(19) United States
(12) Patent Application Publication
(10) Pub. No.: US 2026/0149348 A1
(43) Pub. Date: May 28, 2026

(54) AXIAL FLUX MOTOR

(71) Applicant: GACHON UNIVERSITY OF INDUSTRY-ACADEMIC COOPERATION FOUNDATION, Seongnam-si (KR)

(72) Inventors: Do-Hyeon CHOI, Seongnam-si (KR); Min-Ki HONG, Seoul (KR); Won-Ho KIM, Hwaseong-si (KR); Dong-Woo NAM, Anyang-si (KR); Na-Rim JO, Daegu (KR); Hyo-Gu KIM, Gwangmyeong-si (KR); Hyung-Sub HAN, Seoul (KR); Su-Bin JEON, Seoul (KR); Yun-Ha SONG, Seoul (KR)

(21) Appl. No.: 19/395,643

(22) Filed: Nov. 20, 2025

Related U.S. Application Data
(63) Continuation-in-part of application No. PCT/KR2024/018664, filed on Nov. 22, 2024.

(30) Foreign Application Priority Data
Jun. 23, 2025 (KR) 10-2025-0082658

(51) Int. Cl. H02K 21/24; H02K 1/2795; H02K 3/26

(52) U.S. Cl. CPC H02K 21/24; H02K 1/2795; H02K 3/26; H02K 2203/03

(57) ABSTRACT

Provided is an axial flux motor including a working conductor pattern for reducing motor thickness and AC loss. The present disclosure is directed to reducing the thickness of a back yoke by applying a permanent magnet and a coil in a skewed form to increase the radial length of the back yoke and is also directed to reducing the thickness of an axial flux motor by eliminating a single-sided permanent magnet and directed to reducing AC loss by forming a spline structure in a working conductor pattern.

### CROSS-REFERENCE TO RELATED APPLICATIONS

This application claims priority under 35 U.S.C. § 119 to Korean Patent Application No. 10-2025-0082658, filed on June 23rd, 2025, and to International Application No. PCT/KR 2024/018664, filed on November 22nd, 2024, in the Korean Intellectual Property Office and the World Intellectual Property Organization, respectively, the disclosures of which are incorporated herein by reference in their entirety.

### TECHNICAL FIELD

The following disclosure relates to an axial flux motor, and in particular, to an axial flux motor including a working conductor pattern for reducing motor thickness and AC loss.

### BACKGROUND

Axial flux motors, in which the magnetic poles of a stator and permanent magnets of a rotor are arranged to face each other in a direction parallel to the rotational axis, having the advantages of miniaturization and high power, have been widely used in various fields.

Generally, an axial flux motor includes a toroidal rotor and a stator, which are arranged to face each other with respect to the rotational axis. The rotor includes a permanent magnet and a rotor back yoke composed of a magnetic material, and the stator includes a toroidal magnetic plate with a plurality of teeth spaced apart from each other in the circumferential direction, and coils are wound in the space between the teeth to induce electromagnetic force.

With the recent advancements in printed circuit board (PCB) technology, it is possible to manufacture coreless stators. Coreless stators are manufactured by printing coils on a PCB, rather than winding coils on teeth, thereby reducing stator thickness.

### SUMMARY

An embodiment of the present disclosure is directed to reducing the thickness of a back yoke by applying a permanent magnet and a coil in a skewed form to increase the radial length of the back yoke.

An embodiment of the present disclosure is also directed to reducing the thickness of an axial flux motor by eliminating a single-sided permanent magnet and directed to reducing AC loss by forming a spline structure in a working conductor pattern.

In one general aspect, an axial flux motor includes: a rotor having a toroidal shape and including a plurality of permanent magnets arranged in parallel in a circumferential direction; and a stator having a toroidal shape with the same central axis as the rotor and including at least one printed circuit board having a plurality of printed coils arranged in parallel in the circumferential direction, the printed circuit boards being laminated and connected to each other in at least one of a series or parallel manner, wherein each of the plurality of permanent magnets and coils is formed to extend from an outer diameter of the rotor and the stator to an inner diameter and has a skewed form extending at a predetermined angle in the circumferential direction from a radius connecting the outer diameter and the central axis.

The plurality of permanent magnets and coils may extend in the same direction and at the same angle, but an angle between the radius and the plurality of permanent magnets and coils extending in the skewed form may be less than 45°.

The coil may be formed by at least one working conductor extending radially from the outer diameter of the stator to the inner diameter and an end turn extending between the working conductors.

The working conductor may be formed to extend from the outer diameter to the inner diameter of the stator and may be in a skewed form inclined at a predetermined angle from the radius connecting the outer diameter and an axis.

The working conductor may have a length of 0.3 mm or greater, and a spacing between the working conductors may be between 0.2 mm and 0.3 mm.

A thickness of the printed circuit board may be 0.07 mm or greater, and a spacing between the layers of each printed circuit board may be 0.2 mm or greater.

The rotor may be formed to be spaced apart from the stator by 0.6 mm or greater.

In another general aspect, an axial flux motor includes: a rotor back yoke; a rotor including a plurality of permanent magnets; a stator including at least one substrate; and a stator back yoke, wherein the rotor back yoke, the rotor, the stator, and the stator back yoke are coaxially stacked in an axial direction, the substrate of the stator has a plurality of working conductor patterns, and the stator back yoke may be provided to face the rotor back yoke based on the rotor and stator so as to be a single rotor type in which a permanent magnet may be provided only on one side of the rotor.

The stator back yoke may include an insulating material on an attachment surface facing the stator.

The stator back yoke may include a soft magnetic material.

The soft magnetic material may include at least one of a silicon steel sheet, a laminated iron core, ferrite, an amorphous metal, and a soft magnetic powder core (soft magnetic composite (SMC)).

The stator back yoke may include a U-shaped core formed by rolling an electrical steel plate of a soft magnetic material.

The stator may have at least one fixing hole formed on one side in which the plurality of working conductor patterns are not located.

The stator back yoke may have a bolt insertion hole formed at a position corresponding to the fixing hole of the stator and may be bolt-fastened to the stator.

The rotor back yoke may have a slot structure into which the plurality of permanent magnets are inserted, and the plurality of permanent magnets may be fixed within the slot.

The plurality of permanent magnets may be fixed within the slot and arranged in parallel in the circumferential direction, and permanent magnets of different polarities may be arranged alternately.

The substrate of the stator may be configured as a printed circuit board including a heat dissipation pattern to improve cooling performance.

The stator may be configured such that at least one substrate may be stacked and connected in at least one of a series or parallel manner.

The rotor back yoke may be thicker than the stator back yoke.

In another general aspect, an axial flux motor includes: a rotor having a toroidal shape and including a plurality of permanent magnets arranged in parallel in a circumferential direction; and a stator having a toroidal shape having the same central axis as the rotor and including at least one printed circuit board having a plurality of printed coils arranged in parallel in the circumferential direction, the printed circuit boards being laminated and connected to each other in at least one of a series or parallel manner, wherein the stator may include a plurality of working conductors and an end turn connecting the plurality of working conductors and may include a printed circuit board pattern provided on the printed circuit board, wherein the end turn may be formed to extend in the circumferential direction on the outer and inner circumferences of the printed circuit board, and the plurality of working conductors extend in a straight line in a radial direction between the end turns, have a width W₄ of the outer circumference being greater than a width W₁ at the inner circumference, and are recessed on both sides in the circumferential direction from a first spot between the outer and inner circumferences to the outer circumference.

The first spot may be a midpoint of the working conductor extending in a straight line in the radial direction.

The plurality of working conductors may have a width W₂ at the first spot that is greater than or equal to the width W₁ at the inner circumference and less than the width W₄ at the outer circumference.

The plurality of working conductors may be configured such that the width W₂ at the first spot is greater than the width W₃ at a second spot which is a spot between the first spot and the outer circumference.

The plurality of working conductors may be recessed in a curved shape on both sides in the circumferential direction from the first spot to the outer circumference.

The second spot may be the narrowest spot in the recessed shape between the first spot and the outer circumference.

The second spot may be a midpoint between the first spot and the outer circumference.

The plurality of working conductors may be configured such that the width gradually increases from the inner circumference toward the first spot, when the width W₂ at the first spot is greater than the width W₁ at the inner circumference.

The plurality of working conductors may include at least one via hole in which electrical plating is formed on each of the outer circumference and inner circumference.

Other features and aspects will be apparent from the following detailed description, the drawings, and the claims.

### BRIEF DESCRIPTION OF THE DRAWINGS

FIG. 1 is a perspective view of an axial flux motor according to an exemplary embodiment;

FIGS. 2A and 2B are a plan view illustrating a permanent magnet and a coil of an axial flux motor according to an exemplary embodiment.

FIG. 3 is a plan view illustrating a portion of a coil of an axial flux motor according to an exemplary embodiment.

FIG. 4 is an exploded view illustrating a configuration of an axial flux motor according to an exemplary embodiment.

FIG. 5 is a cross-sectional view illustrating a configuration of an axial flux motor according to an exemplary embodiment.

FIG. 6 is a plan view illustrating a stator of an axial flux motor according to an exemplary embodiment.

FIG. 7 is a plan view illustrating a back yoke of a rotor of an axial flux motor according to an exemplary embodiment.

FIG. 8 is a plan view illustrating a rotor of an axial flux motor according to an exemplary embodiment.

FIGS. 9 and 10 are perspective cross-sectional views illustrating a back yoke of a stator of an axial flux motor according to an exemplary embodiment.

FIG. 11 is a plan view illustrating a printed circuit board of a stator for an axial flux motor according to an exemplary embodiment.

FIG. 12 is a plan view illustrating a working conductor of a stator for an axial flux motor according to an exemplary embodiment.

### DETAILED DESCRIPTION OF EXEMPLARY EMBODIMENTS

The aspects, features, and advantages of the disclosure will become apparent from the following description of the exemplary embodiments with reference to the accompanying drawings, which are set forth hereinafter. The specific structures and functional description will be only provided for the purpose of illustration of the exemplary embodiments according to the concept of the invention, so that the exemplary embodiments of the invention may be embodied in many different forms and should not be construed as being limited to the exemplary embodiments set forth herein. The exemplary embodiments according to the concept of the invention may be changed to diverse forms, so that the invention will be described and illustrated with reference to specific exemplary embodiments. However, it should be understood that the exemplary embodiments according to the concept of the invention are not intended to limit the invention to the specific exemplary embodiments disclosed, but they include all the modifications, equivalences, and substitutions, which are included in the scope and spirit of the invention. It will be understood that although the terms “first,” “second,” etc. may be used herein to describe various devices, these devices should not be limited by these terms. These terms are only used to distinguish one device from another device. Thus, a first device discussed below could be termed a second device and vice versa without departing from the nature of the disclosure. It will be understood that when a device is referred to as being “connected or coupled” to another device, it may be directly connected or coupled to the other device or intervening devices may be present therebetween. In contrast, when a device is referred to as being “directly connected” or “directly coupled” to another device, there are no intervening devices present. Other expressions, such as “between,” “directly between,” “adjacent,” or “directly adjacent” should be understood in a similar manner. The terminology used herein is for the purpose of describing particular exemplary embodiments only and is not intended to limit the invention. As used herein, the singular forms “a,” “an” and “the” are intended to include the plural forms as well, unless the context clearly indicates otherwise. It will be further understood that the terms “comprises” and/or “comprising,” or “includes” and/or “including,” when used in this specification, specify the presence of stated features, integers, steps, operations, devices and/or components, but do not preclude the presence or addition of one or more other features, integers, steps, operations, devices, components and/or groups thereof. Unless otherwise defined, the meaning of all terms including technical and scientific terms used herein are the same as those commonly understood by one of ordinary skill in the art to which the disclosure pertains. It will be further understood that terms, such as those defined in commonly used dictionaries, should be interpreted as having a meaning which is consistent with their meaning in the context of the relevant art and the disclosure, and will not be interpreted in an idealized or overly formal sense unless expressly so defined herein. Hereinafter, exemplary embodiments will be described in detail with reference to the accompanying drawings. The same reference numerals indicated in the drawings refer to similar devices throughout.

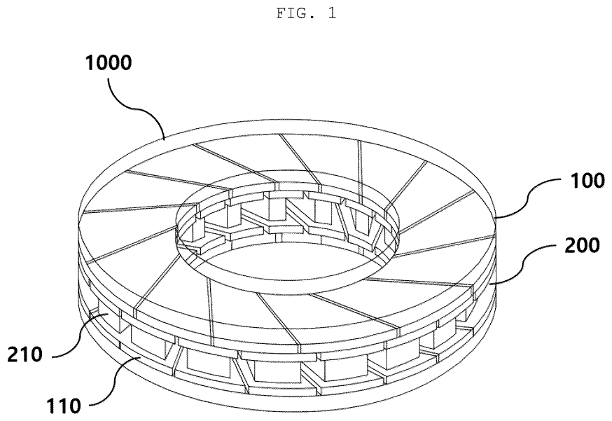

FIG. 1 is a perspective view illustrating an axial flux motor according to an exemplary embodiment.

Referring to FIG. 1, an axial flux motor 1000 according to an exemplary embodiment may have a toroidal shape and include a rotor 100 and a stator 200.

The rotor 100 may have a toroidal shape and include a plurality of permanent magnets 110 arranged in parallel in the circumferential direction. The permanent magnets 110 having different magnetic properties may be alternately arranged in parallel. Here, the plurality of permanent magnets 110 included in the rotor 100 may be formed to extend from the outer diameter to the inner diameter of the rotor 100 but may extend in a skewed form by a predetermined angle in the circumferential direction from a radius connecting the outer diameter and the central axis. Meanwhile, the rotor 100 may further include a back yoke, which requires a magnetic path having a cross-sectional area or greater to prevent magnetic saturation. Here, the magnetic path cross-sectional area of the back yoke is determined by the product of the thickness and radial length (the length extending from the outer diameter to the inner diameter) of the back yoke. In the related art, the magnetic path cross-sectional area is increased by increasing the thickness of the back yoke. In the axial flux motor 1000 according to the present disclosure, the permanent magnets 110 are arranged in a skewed form, so that the radial length of the back yoke may be increased and the thickness of the back yoke may be reduced by the increased radial length.

The stator 200 is positioned between the rotors 100 and may include a core type including teeth 210 and a coreless type using a printed circuit board without the teeth 210. The core type stator 200 may include coils in the teeth 210. However, the axial flux motor 1000 according to the present disclosure will be described as including a coreless stator 200 using a printed circuit board as an embodiment. The stator 200 has a toroidal shape with the same central axis as the rotor 100, and at least one printed circuit board including a plurality of printed coils arranged in parallel in the circumferential direction may be laminated and connected in at least one of a series or parallel manner. In this case, the plurality of coils may extend from the outer diameter of the stator 200 to the inner diameter but may extend in a skewed form by a predetermined angle in the circumferential direction from a radius connecting the outer diameter and the central axis.

The permanent magnets 110 of the rotor 100 and the coils of the stator 200 may be formed in a skewed form, but may be tilted in the same direction and at the same angle to have the same size. In addition, the angle between the radius connecting the outer diameter and the central axis of the rotor 100 and stator 200 and the plurality of permanent magnets 110 and coils extending in a skewed form is preferably less than 45° to allow the outer and inner diameters to be connected.

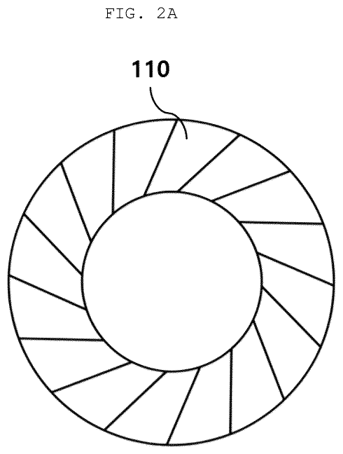

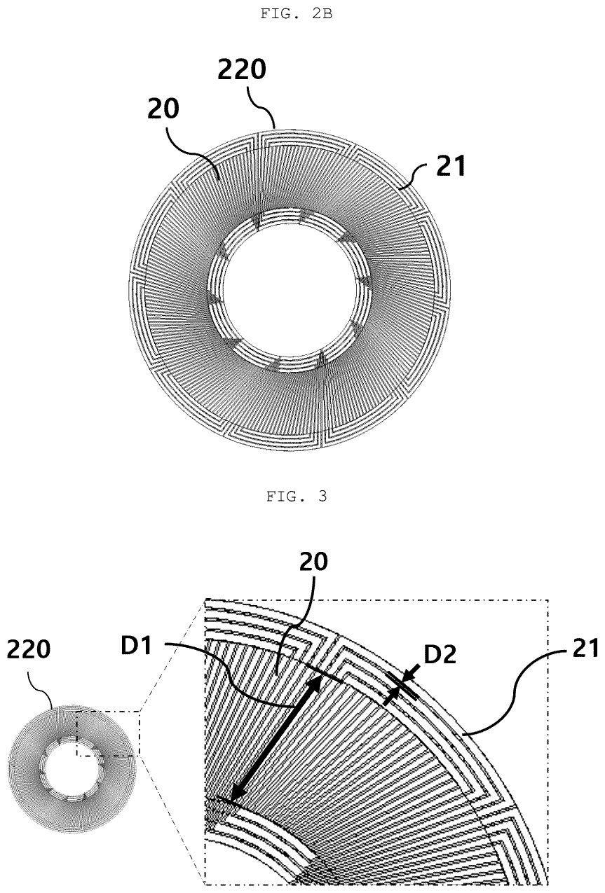

FIGS. 2A and 2B are a plan view illustrating the permanent magnets and coils of an axial flux motor according to an exemplary embodiment.

Referring to FIG. 2A, a plurality of permanent magnets 110 with different magnetic properties may be arranged alternately and in parallel in the circumferential direction. As described with reference to FIG. 1, the plurality of permanent magnets 110 may be formed to extend from the outer diameter to the inner diameter but may be skewed at a predetermined angle in the circumferential direction from the radius connecting the outer diameter and the central axis.

Referring to FIG. 2B, the plurality of printed coils 220 may be arranged in parallel in the circumferential direction. In this case, a printed circuit board including the plurality of printed coils 220 may be formed by stacking a plurality of layers. For example, the printed circuit board may be formed by connecting two substrates, each with six layers, in series. In addition, the plurality of printed coils 220 may be formed by at least one working conductor 20 extending radially from the outer diameter to the inner diameter of the stator 200 and an end turn 21 extending between the working conductors 20. The working conductor 20 may extend from the outer diameter of the stator 200 to the inner diameter thereof and may be formed to skew by a predetermined angle from the radius connecting the outer diameter and the central axis. That is, as the working conductor 20 is formed in a skewed form, the coil 220 may also be formed in a skewed form. Each layer of the printed circuit board may be connected in parallel through a via hole, and the working conductors 20 without the end turn 21 may be connected in parallel through the via hole.

FIG. 3 is a plan view illustrating a portion of a coil of an axial flux motor according to an exemplary embodiment.

Referring to FIG. 3, the printed coil 220 may be formed by the working conductor 20 and the end turn 21.

The working conductor 20 and the end turn 21 of the coil 220 may have a predetermined length D1 and spacing D2 to form a skewed form. For example, the length D1 of the working conductor 20 may be 0.3 mm or more, and the spacing D2 between the working conductor 20 and the end turn 21 may be a value between 0.2 mm and 0.3 mm.

In addition, the thickness of the printed circuit board including the printed coil 220 may be 0.07 mm or greater, and a gap between the layers of the printed circuit board may be 0.2 mm or greater.

In addition, an air gap between the rotor 100 and the stator 200 may be 0.6 mm or greater. In the axial flux motor according to the present invention, by forming the air gap between the rotor 100 and the stator 200 to be 0.6 mm or greater, it is possible to prevent excessive magnetic flux concentration, torque ripple, and overheating that may occur due to the skewed working conductor 20 and the permanent magnets 110 between the rotor 100 and the stator 200.

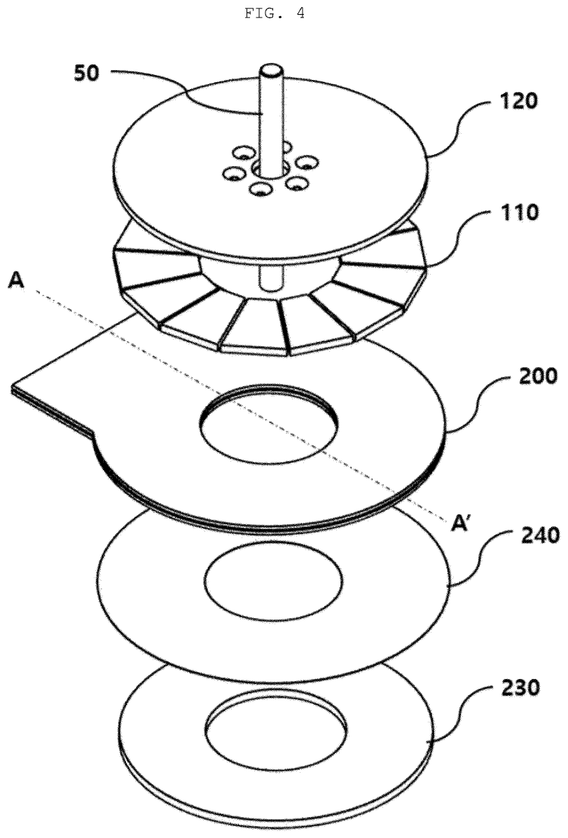

FIG. 4 is an exploded view illustrating a configuration of an axial flux motor according to an exemplary embodiment.

Referring to FIG. 4, the axial flux motor according to an exemplary embodiment may include a rotor back yoke 120, a rotor 100 including a plurality of permanent magnets 110, a stator 200, a stator back yoke 230, and an insulating material 240. Here, the rotor back yoke 120, the rotor 100, the stator 200, the stator back yoke 230, and the insulating material 240 are all toroidal in shape and coaxially stacked in the axial direction, and the stator back yoke 230 may face the rotor back yoke 120 based on the rotor 100 and the stator 200 so as to form a single rotor type in which the permanent magnet 110 is provided only on one side of the rotor 100. In addition, the axial flux motor according to the exemplary embodiment may include a shaft 50 penetrating through the central axis in the vertical direction of the rotor back yoke 120, the rotor 100, the stator 200, and the stator back yoke 230. The rotor back yoke 120 may have a slot structure on one side facing the rotor 100 into which a plurality of permanent magnets 110 may be inserted, and the plurality of permanent magnets 110 may be fixed within the slot.

The rotor 100 may include the plurality of permanent magnets 110. The plurality of permanent magnets 110 may be arranged in parallel in the circumferential direction of the rotor 100. In addition, the plurality of permanent magnets 110 having different polarities of the rotor 100 may alternately be arranged. That is, the plurality of permanent magnets 110 of the rotor 100 having N and S poles may alternately be arranged in parallel in the circumferential direction of the rotor 100.

The stator 200 may include at least one substrate, i.e., a printed circuit board. The stator 200 may be connected by stacking at least one substrate in at least one of a series or parallel manner. The axial flux motor according to the present disclosure is a coreless type with no teeth in the stator 200, and the stator 200 may be formed of a plurality of printed circuit boards.

The substrate of the stator 200 may include a plurality of working conductors. The plurality of working conductors formed on the substrate of the stator 200 may be formed in a linear pattern parallel to the circumference of the stator 200 from the outer circumference of the stator 200 toward the central axis of the stator 200. In addition, the substrate of the stator 200 may include a heat dissipation pattern to enhance cooling performance.

The stator back yoke 230 may be formed to face the rotor back yoke 120 based on the rotor 100 and stator 200, so as to form a single rotor. Here, the stator 200 including a plurality of substrates may be attached to the stator back yoke 230. The stator back yoke 230 may include an insulating material 240 for insulation on an attachment surface to which the stator 200 is attached.

In addition, the stator back yoke 230 may include a soft magnetic material. For example, the stator back yoke 230 may include a soft magnetic material including at least one of a silicon steel sheet, a laminated iron core, a ferrite, an amorphous metal, and a powder core. The soft magnetic material of the stator back yoke 230 may be applied to the width of the working conductor formed on the stator 200.

The stator back yoke 230 may be attached to the stator 200 using an adhesive. In addition, the stator 200 may have at least one fixing hole formed on one side in which the plurality of working conductors are not located, and the stator back yoke 230 may have a bolt insertion hole formed at a position corresponding to the fixing hole formed in the stator 200 and may be bolt-fastened to the stator 200.

That is, with the structure described above, the axial flux motor according to the present disclosure may be formed as a single-rotor type by removing the permanent magnet on one side of the existing double-rotor type and configuring the stator back yoke 230 instead of the rotor back yoke on the rotor side from which the permanent magnet was removed.

In this case, the rotor back yoke 120 may be thicker than the stator back yoke 230. For example, in a case in which the thickness of the rotor back yoke 120 is a, the thickness of the rotor 100 is b, the thickness of the stator back yoke 230 is c, and a bh max (maximum magnetic energy product) value of a plurality of permanent magnets included in the rotor 100 is d, when d has a value of 10 to 55 [MGOe], the axial flux motor may have the highest no-load counter electromotive force [Vms] when the thickness a of the rotor back yoke 120 satisfies b<a<(d*0.1)*b and the thickness c of the stator back yoke 230 satisfies 0.7*b<c<(d*0.08)*b.

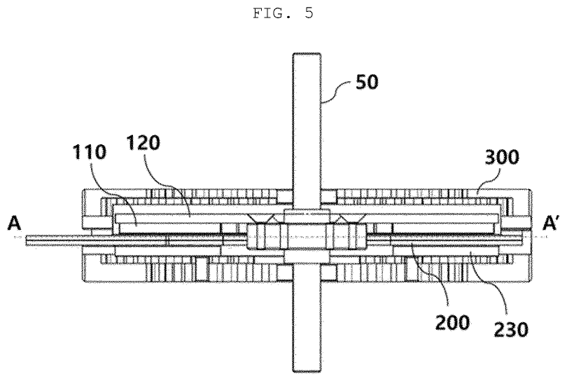

FIG. 5 is a cross-sectional view illustrating a configuration of an axial flux motor according to an exemplary embodiment.

Referring to FIG. 5, an axial flux motor according to an exemplary embodiment may include a rotor back yoke 120, the rotor 100 including a plurality of permanent magnets 110, the stator 200, the stator back yoke 230, the shaft 50, and a cover 300. Here, the rotor back yoke 120, the rotor 100, the stator 200, the stator back yoke 230, and the cover 300 are all toroidal in shape and coaxially stacked in the axial direction, and the stator back yoke 230 may face the rotor back yoke 120 based on the rotor 100 and the stator 200 so as to form a single rotor type in which the permanent magnet is provided only on one side of the rotor 100. In addition, the axial flux motor according to the exemplary embodiment may include a shaft 50 penetrating through the central axis in the vertical direction of the rotor back yoke 120, the rotor 100, the stator 200, and the stator back yoke 230. In addition, the cover 300 may be formed to surround the outer side of the laminated structure of the rotor back yoke 120, the rotor 100, the stator 200, and the stator back yoke 230.

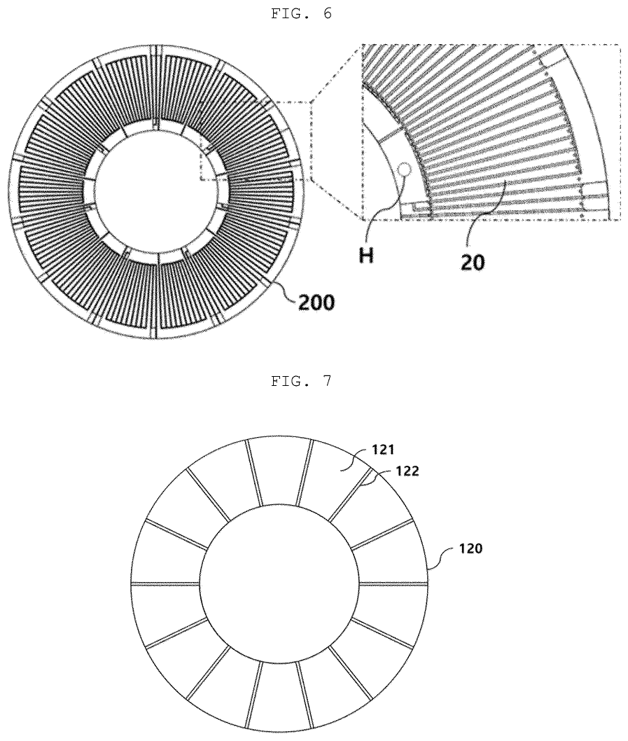

FIGS. 6 to 8 are plan views illustrating the stator 200, the rotor back yoke 120, and the rotor 100 of the axial flux motor according to an exemplary embodiment, respectively.

First, referring to FIG. 6, the stator 200 of the axial flux motor according to an exemplary embodiment may include a plurality of working conductors 20. At least one substrate included in the stator 200 is formed with a plurality of working conductors 20, and the substrates including the working conductors 20 may be stacked in at least one of a series or parallel manner.

In addition, the stator 200 may have at least one fixing hole H formed on one side in which the plurality of working conductors 20 are not located. Referring to FIG. 6, the fixing hole H is illustrated as being located on the inside of the stator 200, but may also be located on the outside depending on the exemplary embodiment, and the number of fixing holes H may vary depending on the exemplary embodiment.

Referring to FIG. 7, the rotor back yoke 120 of the axial flux motor according to an exemplary embodiment may include a slot 121. The rotor back yoke 120 may include partitions 122 formed in the circumferential direction at predetermined intervals and slots 121 formed between the partitions 122 into which the plurality of permanent magnets 110 may be inserted.

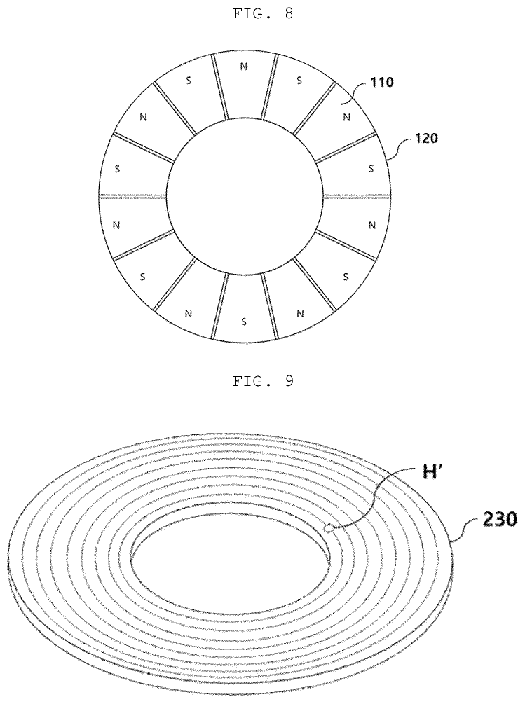

Referring to FIG. 8, the rotor 100 of an axial flux motor according to an exemplary embodiment may include a plurality of permanent magnets, which may be arranged in parallel in the circumferential direction of the rotor 100. As illustrated in FIG. 8, the plurality of permanent magnets having different polarities may be arranged alternately. That is, the plurality of permanent magnets of the rotor 100 may be arranged in parallel in the circumferential direction of the rotor 100 with alternating N and S poles.

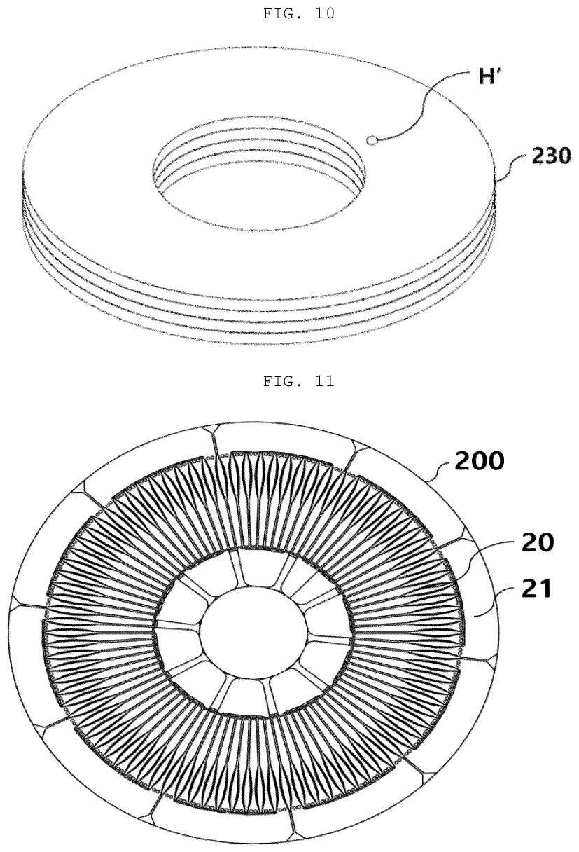

FIGS. 9 and 10 are perspective cross-sectional views illustrating the stator back yoke of an axial flux motor according to an exemplary embodiment.

Referring to FIG. 9, the stator back yoke 230 of the axial flux motor according to the present disclosure may include a U-shaped core formed by rolling a soft magnetic electrical steel plate. The stator back yoke 230 may be formed as a U-shaped core to reduce eddy current loss.

Referring to FIG. 10, the stator back yoke 230 of the axial flux motor according to the present disclosure may include a structure in which at least one soft magnetic electrical steel plate is laminated.

In addition, the stator back yoke 230 may have a bolt insertion hole H′ formed at a location corresponding to the fixing hole H of the stator 200 and be bolt-fastened to the stator 200. The bolt insertion holes H′ of the stator back yoke 230 may be formed to correspond to the location and number of the fixing holes H of the stator 200.

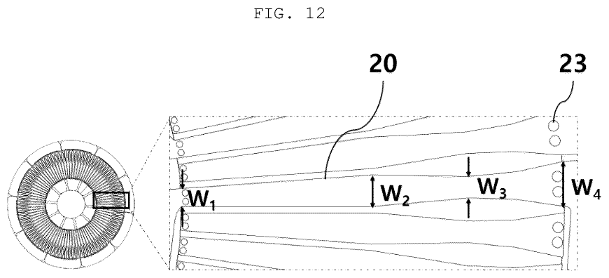

FIG. 11 is a plan view showing a stator for an axial flux motor according to an exemplary embodiment, and FIG. 12 is a plan view showing a working conductor of a stator for an axial flux motor according to an exemplary embodiment.

Referring to FIGS. 11 and 12, the stator 200 for an axial flux motor according to an exemplary embodiment may include a plurality of working conductors 20 and the end turn 21.

The end turn 21 is formed to extend in the circumferential direction along the outer and inner circumferences of the stator 200, and the plurality of working conductors 20 may extend radially in a straight line between the end turns 21.

Here, the plurality of working conductors 20 may have an outer circumferential width W₄ greater than an inner circumferential width W₁ and may be formed in a recessed shape on both sides of the circumference from a first spot between the outer and inner circumference to the outer circumference. Here, the first spot may be a midpoint of the working conductor 20 extending in a straight line in the radial direction. That is, the plurality of working conductors 20 may be formed in a shape that gradually thickens from the inner circumference to the first spot and may be formed in a shape that is recessed on both sides in the circumferential direction from the first spot to the outer circumference.

In addition, the plurality of working conductors 20 may be formed such that a width W₂ at the first spot is greater than or equal to the width W₁ at the inner circumference and less than or equal to the width W₄ at the outer circumference. That is, the size of each width may be defined as W₁≤W₂≤W₄.

In this case, the plurality of working conductors 20 are formed in a shape that is recessed on both sides in the circumferential direction between the first spot and the outer circumference. The width W₃ of the second spot, which is one of the recessed spots, may be formed smaller than the width W₂ at the first spot. The plurality of working conductors 20 may be recessed from the first spot to the outer circumference and may also be recessed in a curved shape. Here, the second spot may be the narrowest spot in which the plurality of working conductors 20 are recessed between the first spot and the outer circumference and may be the midpoint between the first spot and the outer circumference. For example, when each of the plurality of working conductors 20 has a total length of 10 cm, the first spot may be 5 cm, and the second spot may be 7.5 cm from the inner side to the second spot.

In addition, the plurality of working conductors 20 may be formed such that the width W₂ at the first spot is greater than or equal to the width W₁ at the inner circumference. When the width W₂ at the first spot is greater than the width W₁ at the inner circumference, the width may gradually increase from the inner circumference toward the first spot.

The stator 200 according to the present disclosure includes a spline structure in which the working conductor 20 is recessed on both sides in the circumferential direction from the first spot to the outer circumference, thereby solving the problem of AC loss increasing toward the outer circumference due to the permanent magnets widening toward the outer circumference and reducing AC loss by approximately 50% or more compared to conventional PCB patterns.

In addition, the stator 200 according to the present disclosure may include at least one via hole 23 formed with electrical plating on the outer and inner circumferences, respectively. In an exemplary embodiment, two via holes 23 may be formed on each of the outer and inner circumferences. By forming the via holes 23 on the printed circuit board of the stator 200, a plurality of printed circuit boards may be stacked and connected in parallel.

According to the present disclosure, the radial length of the back yoke of an axial flux motor may be increased, thereby maintaining the cross-sectional area of the magnetic path of the back yoke, while reducing the thickness of the back yoke.

In addition, according to the present disclosure, the thickness of the back yoke of the axial flux motor may be reduced.

In addition, according to the present disclosure, by reducing the thickness of the back yoke, the thickness of the permanent magnet may be increased, thereby improving performance.

In addition, according to the present disclosure, by reducing the thickness of the back yoke, the number of layers of the stator may be increased, thereby improving performance.

In addition, according to the present disclosure, the fabrication of a winding structure employing a skewed form may be facilitated using the stator including a printed circuit board.

In addition, according to the present disclosure, the effect of magnetic saturation due to the application of the coil skewed form may be eliminated, regardless of the core type structure including teeth, by using the stator including the printed circuit board.

In addition, according to the present disclosure, by reducing the thickness of the motor, the thickness of the permanent magnet may be increased, thereby improving performance.

In addition, according to the present disclosure, the number of layers of the stator may be increased by reducing the thickness of the motor, thereby improving performance.

In addition, according to the present disclosure, the cost of permanent magnets may be reduced by eliminating the one-sided permanent magnet.

In addition, according to the present disclosure, the magnetic saturation of the stator back yoke and the rotor back yoke may be reduced.

In addition, according to the present disclosure, the stator back yoke is formed with a U-shaped core, thereby reducing eddy current loss.

In addition, according to the present disclosure, the conductor resistance of the PCB stator may be maintained, while AC loss is simultaneously reduced.

In addition, according to the present disclosure, the phenomenon of AC loss increasing toward the outside may be prevented by the permanent magnets widening outward.

In addition, according to the present disclosure, the AC loss effect may be maximized by narrowing the effective conductor width at the spot at which AC loss occurs the most.

In addition, according to the present disclosure, the structure in which a plurality of PCB pattern layers are stacked in parallel may accommodate more conductors per unit area.

In addition, according to the present disclosure, the multilayer structure enables high current handling.

Although the preferred exemplary embodiments of the present disclosure have been described above, the exemplary embodiments disclosed in the present disclosure are not intended to limit the technical spirit of the present disclosure, but are only for explanation. Therefore, the technical spirit of the present disclosure includes not only each disclosed exemplary embodiment, but also a combination of the disclosed exemplary embodiments, and in addition, the scope of the technical spirit of the present disclosure is not limited by these exemplary embodiments. In addition, those skilled in the art to which the present disclosure pertains may make many changes and modifications to the present disclosure without departing from the spirit and scope of the appended claims, and all such appropriate changes and modifications, as equivalents, are to be regarded as falling within the scope of the present disclosure.

What is claimed is:

1. An axial flux motor comprising:
a rotor having a toroidal shape and including a plurality of permanent magnets arranged in parallel in a circumferential direction; and
a stator having a toroidal shape with the same central axis as the rotor and including at least one printed circuit board having a plurality of printed coils arranged in parallel in the circumferential direction, the printed circuit boards being laminated and connected to each other in at least one of a series or parallel manner,
wherein the stator includes a plurality of working conductors and an end turn connecting the plurality of working conductors and includes a printed circuit board pattern provided on the printed circuit board,
wherein the end turn is formed to extend in the circumferential direction on the outer and inner circumferences of the printed circuit board, and the plurality of working conductors extend in a straight line in a radial direction between the end turns, have a width W₄ of the outer circumference being greater than a width W₁ at the inner circumference, and are recessed on both sides in the circumferential direction from a first spot between the outer and inner circumferences to the outer circumference.

2. The axial flux motor of claim 1, wherein the first spot is a midpoint of the working conductor extending in a straight line in the radial direction.

3. The axial flux motor of claim 2, wherein the plurality of working conductors have a width W₂ at the first spot that is greater than or equal to the width W₁ at the inner circumference and less than the width W₄ at the outer circumference.

4. The axial flux motor of claim 3, wherein the plurality of working conductors are configured such that the width W₂ at the first spot is greater than the width W₃ at a second spot which is a spot between the first spot and the outer circumference.

5. The axial flux motor of claim 4, wherein the plurality of working conductors are recessed in a curved shape on both sides in the circumferential direction from the first spot to the outer circumference.

6. The axial flux motor of claim 5, wherein the second spot is a narrowest spot in the recessed shape between the first spot and the outer circumference.

7. The axial flux motor of claim 6, wherein the second spot is a midpoint between the first spot and the outer circumference.

8. The axial flux motor of claim 3, wherein the plurality of working conductors are configured such that the width gradually increases from the inner circumference toward the first spot, when the width W₂ at the first spot is greater than the width W₁ at the inner circumference.

9. The axial flux motor of claim 1, wherein the plurality of working conductors include at least one via hole in which electrical plating is formed on each of the outer circumference and inner circumference.

10. An axial flux motor comprising:
a rotor having a toroidal shape and including a plurality of permanent magnets arranged in parallel in a circumferential direction; and
a stator having a toroidal shape with the same central axis as the rotor and including at least one printed circuit board having a plurality of printed coils arranged in parallel in the circumferential direction, the printed circuit boards being laminated and connected to each other in at least one of a series or parallel manner,
wherein each of the plurality of permanent magnets and coils is formed to extend from an outer diameter of the rotor and the stator to an inner diameter and has a skewed form extending at a predetermined angle in the circumferential direction from a radius connecting the outer diameter and the central axis.

11. The axial flux motor of claim 10, wherein the plurality of permanent magnets and coils extend in the same direction and at the same angle, but an angle between the radius and the plurality of permanent magnets and coils extending in the skewed form is less than 45°.

12. The axial flux motor of claim 10, wherein the coil is formed by at least one working conductor extending radially from the outer diameter of the stator to the inner diameter and an end turn extending between the working conductors.

13. The axial flux motor of claim 12, wherein the working conductor is formed to extend from the outer diameter to the inner diameter of the stator and is in a skewed form inclined at a predetermined angle from the radius connecting the outer diameter and an axis.

14. The axial flux motor of claim 10, wherein the rotor is formed to be spaced apart from the stator by 0.6 mm or greater.

15. An axial flux motor comprising:
a rotor back yoke;
a rotor including a plurality of permanent magnets;
a stator including at least one substrate; and
a stator back yoke,
wherein the rotor back yoke, the rotor, the stator, and the stator back yoke are coaxially stacked in an axial direction, the substrate of the stator has a plurality of working conductor patterns, and the stator back yoke is provided to face the rotor back yoke based on the rotor and stator so as to be a single rotor type in which a permanent magnet is provided only on one side of the rotor.

16. The axial flux motor of claim 15, wherein the stator back yoke includes an insulating material on an attachment surface facing the stator.

17. The axial flux motor of claim 15, wherein the stator back yoke includes a soft magnetic material.

18. The axial flux motor of claim 17, wherein the soft magnetic material includes at least one of a silicon steel sheet, a laminated iron core, ferrite, an amorphous metal, and a soft magnetic powder core (soft magnetic composite (SMC)).

19. The axial flux motor of claim 17, wherein the stator back yoke includes a U-shaped core formed by rolling an electrical steel plate of a soft magnetic material.

20. The axial flux motor of claim 17, wherein the stator back yoke includes a structure in which at least one electrical steel plate of a soft magnetic material is laminated.
